(19) United States
(12) Patent Application Publication
(10) Pub. No.: US 2008/0108380 A1
(43) Pub. Date: May 8, 2008

(54) Mobile radio apparatus

(75) Inventor: Kouji Tokita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/907,824

(22) Filed: Oct. 17, 2007

(30) Foreign Application Priority Data
Nov. 6, 2006 (JP) 2006-300007

(51) Int. Cl. H04M 1/00

(52) U.S. Cl. 455/550.1

(57) ABSTRACT

To provide a mobile radio apparatus enabling an effective use of a communication channel by reducing a retransmission time. The mobile radio apparatus includes a transmitter for transmitting data to a transmission destination apparatus via a radio network; after the lapse of a predetermined time from the data transmission, a receiver for receiving from the transmission destination apparatus either a positive acknowledgement (ACK) indicative of normal data reception in the transmission destination apparatus, or a negative acknowledgement (NACK) indicative of abnormal data reception; and after the data transmission, a retransmission controller for retransmitting the data to the transmission destination apparatus before receiving either the positive acknowledgement or the negative acknowledgement for the data.

### CROSS-REFERENCE TO RELATED APPLICATIONS

This application is based upon and claims the benefit of priority from the prior Japanese Patent Application No. 2006-300007, filed on Nov. 6, 2006, the entire contents of which are incorporated herein by reference.

### BACKGROUND OF THE INVENTION

1. Field of the Invention

The present invention relates to a mobile radio apparatus such as a mobile telephone set, and more particularly a mobile radio apparatus performing efficient retransmission control of data transmission.

2. Description of the Related Art

The mobile radio apparatus such as the mobile telephone set transmits data in uplink communication, using a communication channel established between to a radio base station apparatus. The communication channel is commonly used for a plurality of mobile radio apparatuses existent in an area controlled by the radio base station apparatus concerned. Therefore, in case that the number of mobile radio apparatuses requesting uplink communication is greater than the number of communication channels, the radio base station apparatus schedules mobile radio apparatuses to be assigned to a communication channel, and on completion of the data transmission, the radio base station apparatus controls to assign the communication channel of interest to a mobile radio communication apparatus which is standing by.

FIG. 1 shows a diagram illustrating communication channel assignment. In the figure, an example of assigning two mobile radio apparatuses MS1, MS2 to one communication channel is shown. At the beginning, a communication channel is in an idle state because the mobile radio apparatuses MS1, MS2 do not perform uplink communication. In this state, when the mobile radio apparatus MS1 requests communication, the radio base station apparatus (not shown) assigns a communication channel to the mobile radio apparatus MS1, and the mobile radio apparatus MS1 starts data transmission accordingly. During data transmission from the mobile radio apparatus MS1, the mobile radio apparatus MS2 issues a data transmission request. However, since the communication channel is already assigned to the mobile radio apparatus MS1, the mobile radio apparatus MS2 waits for data transmission. Then, at the time point that the data transmission from the mobile radio apparatus MS1 is completed, the radio base station apparatus assigns the communication channel to the mobile radio apparatus MS2, and then, the mobile radio apparatus MS2 completes the data transmission.

As such, when the plurality of mobile radio apparatuses shares the communication channel, a mobile radio apparatus is required to wait for data transmission, depending on the use state of the communication channel. Therefore, it is desired to perform efficient data transmission to the maximum extent, so as to reduce the transmission time.

Meanwhile, during the data transmission, when the reception side (radio base station apparatus) cannot receive the data normally, a retransmission of the data is performed. When the data is normally received, ACK (positive acknowledgement) is returned from the radio base station apparatus to the mobile radio apparatus, while when the data is not received normally, NACK (negative acknowledgement) is returned. On receiving NACK, the mobile radio apparatus controls to retransmit the data corresponding to the above NACK. Until ACK is received from the radio base station apparatus, the mobile radio apparatus continues to retransmit the data having not been received normally, during which the mobile radio apparatus continues using the communication channel concerned. The data retransmission is controlled by ARQ (Automatic Repeat Request) or HARQ (Hybrid ARQ). ARQ and HARQ are specified by 3GPP (3rd Generation Partnership Project), as the standard specifications of the mobile communication system.

FIG. 2 shows a diagram illustrating the conventional retransmission control. FIG. 2 exemplifies a case of transmitting data being divided into five (5) blocks. Further, for the sake of simple explanation, time is divided into each time apparatus for transmitting one block. Accordingly, as first-time transmissions, block data 1-5 are transmitted successively from the mobile radio apparatus MS at times 1-5. ACK/NACK returned from a radio base station apparatus BS is received in the mobile radio apparatus MS with the delay of four (4) block times. For example, at time 5, the mobile radio apparatus MS receives ACK/NACK for block data 1 having been transmitted at time 1. In case of FIG. 2, because ACK for block data 1 is received, it is not necessary to retransmit block data 1. At time 6, since the mobile radio apparatus MS receives ACK for block data 2, in other words, since there is no block data corresponding to NACK at the time point of time 6, no data is transmitted at time 6. Similarly, the mobile radio apparatus MS also receives ACK for block data 3, 4, no data is transmitted at times 7, 8. Accordingly, the period of times 6-8 is a period of no data transmission, though the communication channel is being occupied.

Then, at time 9, because NACK for block data 5 is received, the mobile radio apparatus MS retransmits block data 5. ACK/NACK for the above retransmitted block data 5 is not returned before time 13, and therefore, the period concerned (times 10-12) is a wasted period of no data transmission. After all, in case of FIG. 2, NACK for block data 5 is received again at time 13, and therefore, block data 5 is retransmitted again. The radio base station apparatus BS normally receives block data 5 at the third-time transmission. In the above case, it is at time 17 that ACK for block data 5 is received in the mobile radio apparatus MS, and therefore, the data transmission is completed at the time point of time 17. As a result, after the lapse of time 17, the communication channel concerned is assigned to a next mobile radio apparatus which has been standing by.

In the following patent document 1, the official gazette of the Japanese Unexamined Patent Publication No. 2000-92150, when an information originating apparatus 1 transmits information DN1 to an information receiving apparatus 2, there has been disclosed a retransmission method for retransmitting the information DN1 at a predetermined period until an acknowledge AK1 is received from the information receiving apparatus 2.

As described above, when retransmitting data awaited until receiving NACK, there is produced an idle time having no data transmission. As a result, a long data retransmission time is required, and the time of a communication channel being occupied in vain becomes long.

### SUMMARY OF THE INVENTION

Accordingly, it is an object of the present invention to provide a mobile radio apparatus enabling an efficient use of a communication channel by reducing retransmission time.

As a first configuration of a mobile radio apparatus according to the present invention to achieve the aforementioned object, the mobile radio apparatus includes: a transmitter transmitting data to a transmission destination apparatus via a radio communication channel; a receiver receiving from the transmission destination apparatus either a positive acknowledgement indicating that the data has been received normally or a negative acknowledgement indicating that the data has not been received normally in the transmission destination apparatus, after the lapse of a predetermined time from the transmission of the data; and a retransmission controller retransmitting the data to the transmission destination apparatus before the positive acknowledgement or the negative acknowledgement for the data is received, after the transmission of the data.

As a second configuration of the mobile radio apparatus according to the present invention, in the above first configuration, the retransmission controller repeats retransmission of the data until the receiver receives the positive acknowledgement for the data.

As a third configuration of the mobile radio apparatus according to the present invention, in the above first configuration, while the receiver does not receive the positive acknowledgement for the data, the retransmission controller repeats the data retransmission until the number of data retransmission times reaches a preset maximum number of retransmission times.

As a fourth configuration of the mobile radio apparatus according to the present invention, in the above first configuration, when the receiver receives the negative acknowledgement for the data after the data transmission, the retransmission controller retransmits the data, and before the receiver receives either the positive acknowledgement or the negative acknowledgement for the retransmitted data, the retransmission controller retransmits the data again.

As a fifth configuration of the mobile radio apparatus according to the present invention, in the above first configuration, the transmitter successively transmits a plurality of data, and after the transmission of the plurality of data, in case there are a plurality of data for which positive acknowledgements are not received yet, the retransmission controller retransmits the plurality of data for which the positive acknowledgements are not received, in order from the data transmitted at the earliest time.

As a sixth configuration of the mobile radio apparatus according to the present invention, in the above fifth configuration, the receiver receives information related to an error rate of each data when the data is received in the transmission destination apparatus, together with the positive acknowledgement or the negative acknowledgement, and after the plurality of data, for which the positive acknowledgement are not received, are retransmitted in order from the data transmitted at the earliest time, in case there are a plurality of data for which the negative acknowledgements are received, the retransmission controller retransmits the plurality of data for which the negative acknowledgements are received, in order from the data having the highest error rate.

Further scopes and features of the present invention will become more apparent by the following description of the embodiments with the accompanied drawings.

### BRIEF DESCRIPTION OF THE DRAWINGS

FIG. 1 shows a diagram illustrating communication channel assignment.

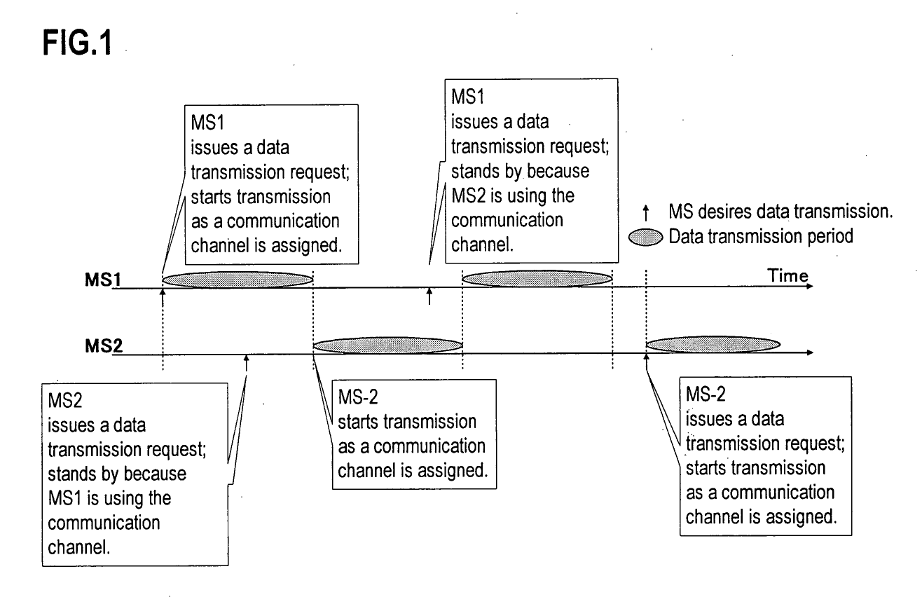

FIG. 2 shows a diagram illustrating the conventional retransmission control.

FIG. 3 shows a diagram illustrating an exemplary configuration of a mobile radio apparatus according to an embodiment of the present invention.

FIG. 4 shows a diagram illustrating first retransmission control according to an embodiment of the present invention.

FIG. 5 shows a diagram illustrating second retransmission control according to an embodiment of the present invention.

FIG. 6 shows a diagram illustrating third retransmission control according to an embodiment of the present invention.

### DETAILED DESCRIPTION OF THE PREFERRED EMBODIMENTS

The preferred embodiment of the present invention is described hereinafter referring to the charts and drawings. However, it is to be noted that the technical scope of the present invention is not limited to the embodiments described below.

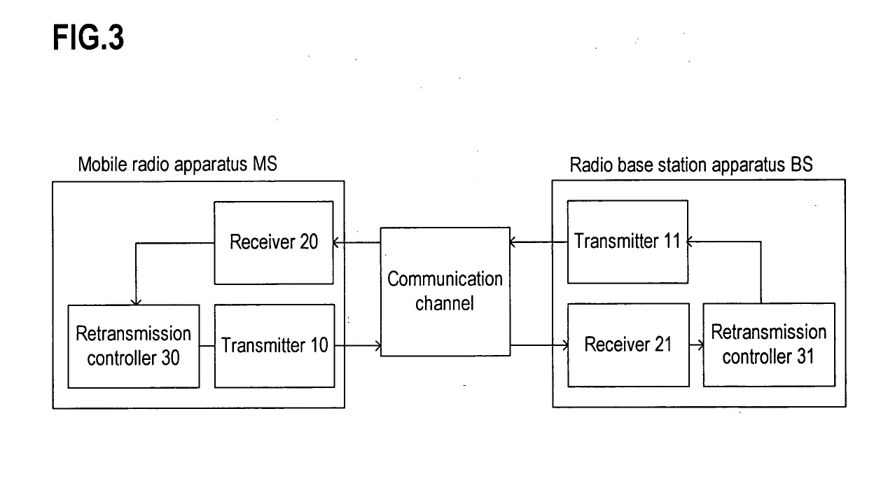

FIG. 3 shows a diagram illustrating an exemplary configuration of a mobile radio apparatus according to an embodiment of the present invention. A mobile radio apparatus MS is, for example, a mobile telephone set in a third-generation (3G) mobile communication system such as W-CDMA. The mobile radio apparatus MS is constituted of a transmitter 10, a receiver 20 and a retransmission controller 30. Additionally, a radio base station apparatus BS which communicates with the mobile radio apparatus MS through a communication channel is also constituted of a transmitter 11, a receiver 21 and a retransmission controller 31.

Data transmitted from transmitter 10 of the mobile radio apparatus MS is received in receiver 21 of the radio base station apparatus BS. Retransmission controller 31 generates ACK when receiver 21 received the data normally, while retransmission controller 31 generates NACK when receiver 21 was not able to receive the data normally. Transmitter 11 then transmits the above ACK/NACK. Receiver 20 of the mobile radio apparatus MS then receives ACK/NACK from the radio base station apparatus BS. Retransmission controller 30 retransmits the data corresponding to NACK returned from transmitter 10, and also executes retransmission control described hereafter, which is characteristic to the present invention.

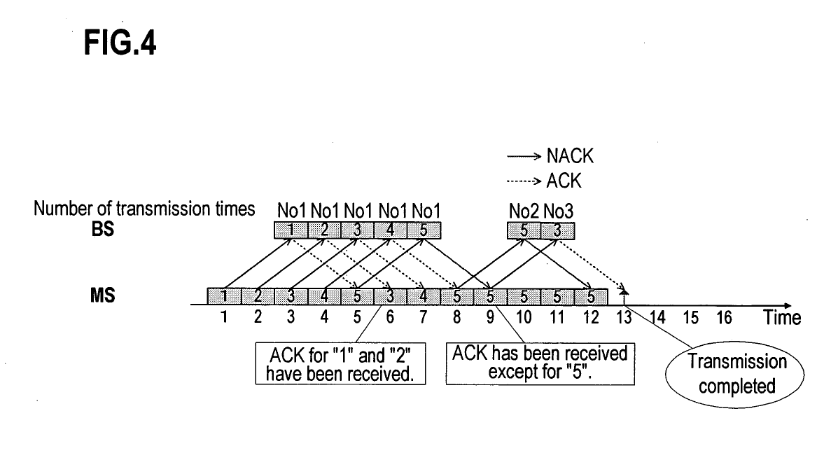

FIG. 4 shows a diagram illustrating first retransmission control according to an embodiment of the present invention. In the first retransmission control, in an idle time before each ACK/NACK corresponding to a predetermined data is received, the data for which ACK have not been received are retransmitted.

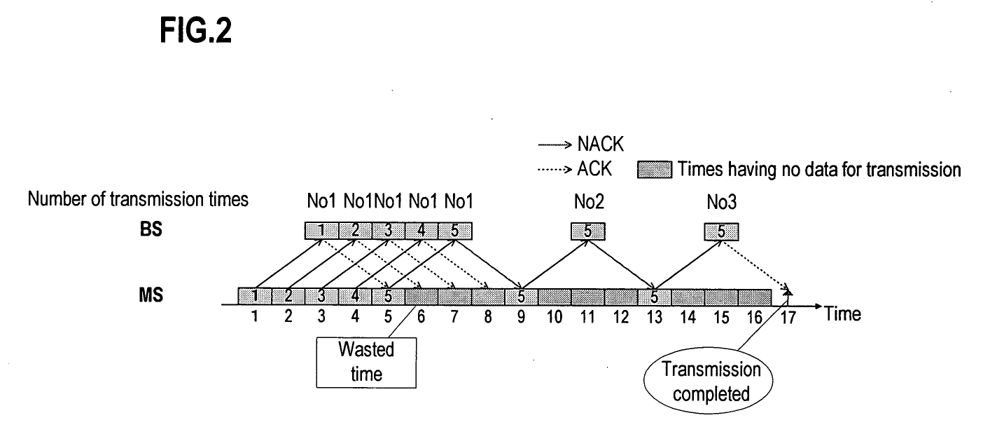

Similar to FIG. 2, FIG. 4 exemplifies a case of transmitting data being divided into five (5) blocks, and time is divided into each time apparatus for transmitting one block data. Accordingly, as first-time transmissions, block data 1-5 are transmitted successively from transmitter 10 of the mobile radio apparatus MS at times 1-5. ACK/NACK transmitted from the radio base station apparatus BS is received in receiver 10 of the mobile radio apparatus MS with the delay of four (4) block times. For example, at time 5, the mobile radio apparatus MS receives ACK/NACK of block data 1 transmitted at time 1. Since ACK for block data 1 is received, it is not necessary to retransmit this block data 1. Further, at time 5, the first-time transmission of block data 5 is performed.

At time 6, receiver 20 of mobile radio apparatus MS receives ACK for block data 2. At the time point of time 6, the transmissions of block data 3-5 have been completed, and NACK has not been received either. However, ACK/NACK for each block data 3-5 has not been received yet. According to the present invention, in such the situation, assuming that NACK will be received at a later time for block data 3-5 which have not been received yet, retransmission controller 30 controls to retransmit block data for which ACK/NACK has not been received yet, before receiving ACK/NACK of the block data having not been received yet. The retransmission order (sequence) is the same as the transmission order in the first-time transmissions. Therefore, at time 6, block data 3 is transmitted from transmitter 10.

At time 7, receiver 20 of the mobile radio apparatus MS receives ACK for block data 3, while at that time point, ACK/NACK for each block 4, 5 has not been received yet. Although NACK has not been received, retransmission controller 30 retransmits block data 4 having an earlier retransmission order between block data 4, 5 for which ACK/NACK has not been received.

At time 8, receiver 20 of the mobile radio apparatus MS receives ACK for block data 4, while at that time point, ACK/NACK for block 5 has not been received yet. Therefore, retransmission controller 30 retransmits block data 5 for which ACK/NACK has not been received yet. In other words, at time 8, the second time transmission of block data 5 is performed.

At time 9, receiver 20 of the mobile radio apparatus MS receives NACK for block data 5. The above NACK corresponds to the first-time transmission of block data 5. At the timing of receiving NACK, retransmission controller 30 controls to retransmit the block data corresponding to the NACK concerned. Accordingly, in response to the above NACK, retransmission controller 30 controls to retransmit block data 5 again, subsequently to the retransmission thereof performed at time 8. In other words, at time 9, the third-time transmission of block data 5 is performed.

Then, at times 10, 11, although receiver 20 of the mobile radio apparatus MS does not receive ACK/NACK corresponding to the second-time transmission of block data 5, retransmission controller 30 controls to retransmit block data 5, because the block data for which ACK has not been received is block data 5 only. Thus, block data 5 is transmitted from transmitter 10.

Further, at time 12, receiver 20 of the mobile radio apparatus MS receives NACK corresponding to the second-time transmission of block data 5. Accordingly, retransmission controller 30 controls to retransmit the block data again, in response to the above NACK for block data 5.

Subsequently, at time 13, receiver 20 of the mobile radio apparatus MS receives ACK corresponding to the third-time block data transmission. With this, the reception of ACK has been completed for the entire block data transmitted, and thus, the transmissions are completed. In case of FIG. 4, the transmission is completed at time 13, and as a result, as compared to the conventional retransmission control shown in FIG. 2, the transmission completion timing becomes earlier by 4 block times.

In the retransmission control characteristic to the present invention; by effectively using an idle time before receiving ACK/NACK, each block data for which ACK/NACK has not been received is retransmitted, as compared to the conventional retransmission control shown in FIG. 2. As a result, the retransmission timing of the block data corresponding to NACK becomes earlier. Also, because of the increased number of retransmission times, the timing of receiving ACK for each data becomes earlier, which results in a shorter time to complete the transmission. Additionally, on the receiving side (radio base station apparatus BS), there is performed a process for improving a receiving characteristic by synthesizing the retransmitted data. When the number of retransmission times increases, the receiving characteristic is improved, which causes an increased probability of normal reception.

Now, in the following description, each operation in transmitter 10, receiver 20 and retransmission controller 30 is generically referred to as the operation of the mobile radio apparatus MS.

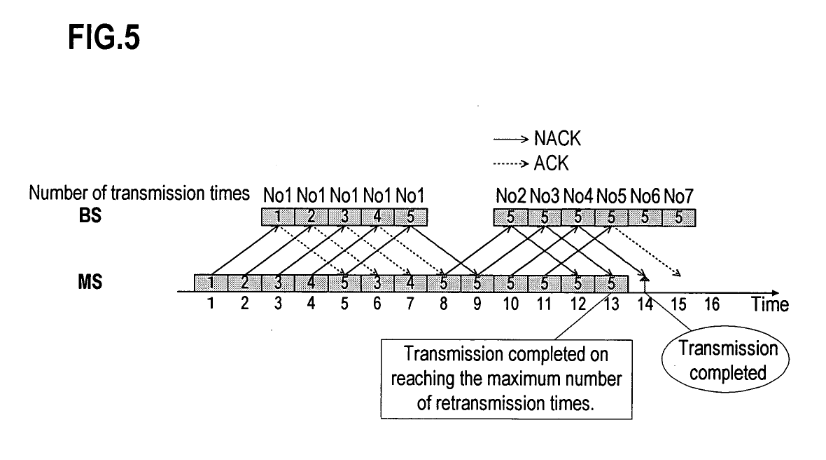

FIG. 5 shows a diagram illustrating second retransmission control according to an embodiment of the present invention. The second retransmission control is an exemplarily case of restricting the number of retransmission times in the first retransmission control. Namely, there is set a maximum number of retransmission times is set, which is 7 in the example shown in FIG. 5. In the example shown in FIG. 4, after time 8, the mobile radio apparatus MS continues transmitting block data 5 for which ACK has not been received. Corresponding to the third-time transmission of block data 5, ACK is received at time 13. Meanwhile, in the example shown in FIG. 5, NACK corresponding to the third-time block data transmission is received at time 13, and block data 5 is retransmitted again at time 13. Since the above transmission is the seventh-time transmission of block data 5, the transmission of block data 5 is completed by the above transmission.

Accordingly, at time 14, even if the mobile radio apparatus MS receives NACK for block data 5, block data 5 is not transmitted. In the example shown in FIG. 5, there is illustrated an example of receiving ACK at time 15 corresponding to the fifth-time transmission of block data 5. Here, even in the assumed case that NACK is received at time 15 and that NACK is also received corresponding to the seventh-time (final) transmission of block data 5, the retransmission of block data 5 is not performed. At the time point of time 13, the uplink communication channel is released once, and when there is another mobile radio apparatus waiting for transmission, the communication channel is assigned to be used for the other mobile radio apparatus concerned. Accordingly, the mobile radio apparatus MS which has failed to transmit block data 5 newly issues a data transmission request to the radio base station apparatus BS.

As such, in the second control also, similar to the first retransmission control, wasted idle time can be avoided by transmitting each block data for which ACK/NACK has not been received, without waiting for receiving NACK. Further, since the time to reaching the maximum number of retransmission times is reduced, and the transmission is completed at the time point of reaching the maximum number of retransmission times irrespective of receiving or not receiving ACK for the entire transmission data, it becomes possible to make the transmission completion timing earlier. With this, a communication channel can be assigned at earlier timing to another mobile radio apparatus which is standing by, and thus, an efficient communication channel use can be obtained.

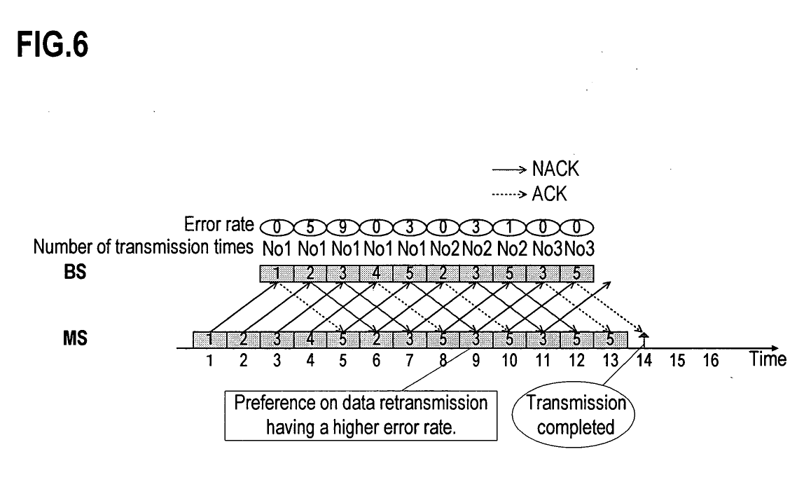

FIG. 6 shows a diagram illustrating third retransmission control according to an embodiment of the present invention. In the third retransmission control, similar to the first retransmission control and the second retransmission control, each block data for which ACK/NACK has not been received is transmitted without waiting for receiving NACK. At this time, in regard to the retransmission order of the block data, the retransmission order is determined in consideration of not only the first-time transmission order but also a numeric value representing the degree of errors (hereafter referred to as error rate) being notified together with NACK. The error rate in case of ACK is defined as “0”, while in case of NACK, as the number of error bits increases, so the error rate becomes greater. More specifically, although the retransmission order of first-time retransmissions is determined according to the first-time transmission, in the second-time retransmissions and thereafter, the retransmission order is determined on the basis of the error rate.

The mobile radio apparatus MS transmits either an error detection code (CRC, as an example) or an error correction code, in addition to a transmission data. Retransmission controller 31 in the radio base station apparatus BS obtains the error rate of the transmission data on the basis of the error detection code or the error correction code, and notifies the mobile radio apparatus MS of the above error rate, together with ACK/NACK.

FIG. 6 exemplifies a case of transmitting data being divided into five (5) blocks, as in the case shown in FIG. 4, and time is divided into each time apparatus for transmitting one block. Accordingly, as first-time transmissions, block data 1-5 are successively transmitted at times 1-5, from the mobile radio apparatus MS. ACK/NACK transmitted from the radio base station apparatus BS is received in the mobile radio apparatus MS with the delay of four (4) block times.

At time 5, the first-time transmission of block data 5 is performed, and also, the mobile radio apparatus MS receives ACK/NACK for block data 1 having been transmitted at time 1. With this, the retransmission of block data 1 is not necessary.

At time 6, the mobile radio apparatus MS receives NACK for block data 2. Therefore, the mobile radio apparatus MS retransmits block data 2. At this time, the block data error rate is assumed to be “5”. Further, at time 7, the mobile radio apparatus MS receives NACK for block data 3. Therefore, the mobile radio apparatus MS retransmits block data 3. At this time, the error rate of block data 3 is assumed to be “9”.

At time 8, the mobile radio apparatus MS receives ACK for block data 4. Accordingly, at this time 8, among each block data 2, 3, 5 for which no ACK has been received, either one block data is to be retransmitted. Among the above block data, since the first-time retransmissions have been completed for block data 2 and 3, the retransmission of block data 5 is performed.

At time 9, the mobile radio apparatus MS receives NACK for block data 5. The error rate of block data 5 is assumed to be “3”. Ordinarily, at the timing of receiving NACK, the block data corresponding to the above NACK is retransmitted. However, in this case, the block data to be retransmitted is selected in consideration of the error rate. Namely, at the time point of time 9, the block data for which ACK have not been received (in other words, NACK may possibly be received later) are block data 2, 3 and 5. When comparing the most recent error rates of the above block data;

the error rate of block data 2=“5”,

the error rate of block data 3=“9”, and

the error rate of block data 5=“3”.

A larger error rate signifies a larger number of error bits and a higher possibility of repeated reception of NACK (which results in a higher possibility of repeated retransmissions). Therefore, to reduce the retransmission time, it is effective to retransmit the block data having the highest error rate as early as possible. Thus, at time 9, block data 3 having the highest error rate is transmitted.

At time 10, the mobile radio apparatus MS receives ACK for block data 2. Accordingly, although the block data having the highest error rate except for block data 3 is block data 2, block data 5 is retransmitted at time 10, because there is no need of retransmitting block data 2. As such, in regard to the second-time retransmission and thereafter, such the retransmissions are performed in order from the highest error rate, instead of the order of the first-time transmissions. Since it is not possible to compare the error rates in the first-time retransmissions, the first-time retransmissions are performed according to the order of the first-time transmissions.

Additionally, at time 9, in the assumed case that the retransmissions are performed in order of the first-time transmissions, block data 2 is to be transmitted. However, for block data 2, ACK is received at the next time 10, which results in a useless retransmission of block data 2 at time 9. Therefore, more efficient retransmission can be realized by preferentially retransmitting a block data having a higher possibility of receiving NACK (that is, a higher data error rate).

From time 11 and thereafter, third-time retransmissions are started. At time 11, the mobile radio apparatus MS receives NACK for block data 3. The error rate of block data 3 is assumed to be “3”. Namely, the error rate of the block data has been decreased from “9” to “3”. At the time point of time 11, the block data for which ACK have not been received are block data 3 and 5. When comparing the most recent error rates of block data 3 and 5;

the error rate of block data 3=“3”, and

the error rate of block data 5=“3”,

which are identical. In such the case, block data 3 is retransmitted according to the first-time transmission order. When the error rates are different, the block data having a higher error rate is retransmitted, needless to say.

At time 12, the mobile radio apparatus MS receives NACK for block data 5. Namely, since ACK for block data 5 is not received, and block data 3 has been retransmitted at time 11, block data 5 is retransmitted at time 12.

At time 13, the mobile radio apparatus MS receives NACK for block data 3. At this time point, a block data for which ACK has not been received is only block data 5. Accordingly, at time 13, block data 5 is retransmitted successively to time 12. Thereafter, at time 14, ACK for block data 5 is received, and the data transmission is completed accordingly.

According to the present invention, it becomes possible to avoid a wasted idle time during which no data is transmitted on an uplink communication channel occupied by a mobile radio apparatus, which enables efficient data retransmission. Accordingly, it becomes possible to reduce a retransmission time and to use the communication channel effectively.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A mobile radio apparatus comprising:
a transmitter transmitting data to a transmission destination apparatus via a radio communication channel;
a receiver receiving from the transmission destination apparatus either a positive acknowledgement indicating that the data has been received normally or a negative acknowledgement indicating that the data has not been received normally in the transmission destination apparatus, after the lapse of a predetermined time from the transmission of the data; and
a retransmission controller retransmitting the data to the transmission destination apparatus before the positive acknowledgement or the negative acknowledgement for the data is received, after the transmission of the data.

2. The mobile radio apparatus according to claim 1,
wherein the retransmission controller repeats retransmission of the data until the receiver receives the positive acknowledgement for the data.

3. The mobile radio apparatus according to claim 1,
wherein, while the receiver does not receive the positive acknowledgement for the data, the retransmission controller repeats the data retransmission-until the number of data retransmission times reaches a preset maximum number of retransmission times.

4. The mobile radio apparatus according to claim 1,
wherein when the receiver receives the negative acknowledgement for the data after the data transmission, the retransmission controller retransmits the data, and before the receiver receives either the positive acknowledgement or the negative acknowledgement for the retransmitted data, the retransmission controller retransmits the data again.

5. The mobile radio apparatus according to claim 1,
wherein the transmitter successively transmits a plurality of data, and after the transmission of the plurality of data, in case there are a plurality of data for which positive acknowledgements are not received yet, the retransmission controller retransmits the plurality of data for which the positive acknowledgements are not received, in order from the data transmitted at the earliest time.

6. The mobile radio apparatus according to claim 5,
wherein, the receiver receives information related to an error rate of each data when the data is received in the transmission destination apparatus, together with the positive acknowledgement or the negative acknowledgement, and
after the plurality of data, for which the positive acknowledgement are not received, are retransmitted in order from the data transmitted at the earliest time, in case there are a plurality of data for which the negative acknowledgements are received, the retransmission controller retransmits the plurality of data for which the negative acknowledgements are received, in order from the data having the highest error rate.
